(19) United States
(12) Patent Application Publication
(10) Pub. No.: US 2011/0008535 A1
(43) Pub. Date: Jan. 13, 2011

(54) APPARATUS AND METHOD FOR RESIST APPLICATION

(75) Inventors: Kyoichi MORI, Kodama-gun (JP); Noritake SHIZAWA, Kodama-gun (JP); Takashi TARUMITSU, Kodama-gun (JP); Shinjiro ISHII, Kodama-gun (JP); Kentaro KOIKAWA, Kodama-gun (JP)

Correspondence Address: MATTINGLY & MALUR, P.C., 1800 DIAGONAL ROAD, SUITE 370, ALEXANDRIA, VA, 22314, US

(73) Assignee: HITACHI HIGH-TECHNOLOGIES CORPORATION, Tokyo (JP)

(21) Appl. No.: 12/826,723

(22) Filed: Jun. 30, 2010

(30) Foreign Application Priority Data
Jul. 8, 2009 (JP) 2009-161494

(51) Int. Cl. B05D 1/26; B05C 11/02

(52) U.S. Cl. 427/210; 118/71

(57) ABSTRACT

Spots of a resist are deposited in a concentric pattern on both sides of an annular disk. A motor which rotates the disk has a rotating shaft that can be inserted into or removed from a through-hole in the disk. Two ink-jet heads provided on the obverse and reverse sides, respectively, of the disk substrate are provided such that the heads are not in contact with the sides. A carriage for causing the two ink-jet heads to move radially inward or outward with respect to the disk substrate is also provided. The ink-jet heads are moved by the carriage while the disk is rotated by the motor to apply the spots of the resist.

### FIELD OF THE INVENTION

The present invention relates to an apparatus and a method for resist application to a transfer element before fine structures are formed on a surface of the substrate by means of a nanoimprint apparatus. More particularly, the present invention relates to an apparatus and a method by which a resist can be applied simultaneously to both sides of a transfer element such as an annular, doughnut-shaped disk of substrate before fine structures are formed on the substrate's surfaces by means of a nanoimprint apparatus.

### BACKGROUND OF THE INVENTION

With remarkable advances in the performance of computers and other information equipment, the volume of information that is handled by users has been constantly increasing and the unit of measurement is now in terabytes rather than gigabytes. Under these circumstances, there exists an ever-growing demand for semiconductor devices such as information storage/reproduce equipment and memories that are capable of recording at even higher densities.

To achieve higher recording densities, technologies for even finer microfabrication are required. Conventional photolithography which uses the exposure process is capable of microfabrication over a large area in one step; however, since its resolution is not finer than the wavelength of light, conventional photolithography is inevitably unsuitable for creating fine structures smaller than the wavelength of light (say, 100 nm and less). Technologies currently available for processing finer structures than the wavelength of light include exposure using electron beams, exposure using X-rays, and exposure using ion beams. However, pattern formation with an electron beam lithographic apparatus differs from patterning by one-shot exposure using such light sources as i-line and an excimer laser in that the more patterns that need be written with electron beams, the longer the time that is required for writing (exposure). Therefore, as the recording density increases, the time it takes to form a fine-featured pattern is prolonged to cause a marked drop in production throughput. With a view to forming patterns at a faster speed by the e-beam lithographic equipment, the development of a method for one-shot irradiation of geometric figures is underway in which combinations of variously shaped masks are subjected to one-shot exposure to electron beams; however, the e-beam lithographic apparatus that uses the method for one-shot irradiation of geometric figures is not only bulky but it also needs an additional mechanism for controlling the positions of masks to an even higher precision; this increases the cost of the lithographic apparatus, eventually leading to a higher cost for manufacturing the media.

Printing-based approaches have been proposed as an alternative to the conventional exposure technologies for creating fine structures smaller than the wavelength of light. See, for example, US 005772905A which describes an invention relating to the technology of nanoimprint lithography (NIL). The technology of nanoimprint lithography (NIL) is a technique in which a pattern of predetermined fine structures is formed on a mold by exposure to electron beams or using some other methods of creating finer structures than the wavelength of light and the mold is urged under pressure against a resist-coated transfer substrate so that the fine-structured pattern is transferred to the resist coating on the transfer substrate. As long as the mold is available, there is no particular need to employ an expensive exposure unit but an apparatus in the class of ordinary printing presses will suffice to produce replicas in large quantities; hence, in comparison with the conventional methods such as exposure to electron beams, there is achieved a marked improvement in throughput whereas the manufacturing cost is significantly reduced.

When a thermoplastic resin is used as a resist material in the technology of nanoimprint lithography (NIL), transfer is performed with the thermoplastic resin being heated under pressure to a temperature near its glass transition temperature (Tg) or higher. This approach is called a thermal transfer process. The thermal transfer process has the advantage of permitting the use of general-purpose, thermoplastic resins. If a photosensitive resin is used as a resist in the NIL technology, a photocurable resin that hardens upon exposure to light such as UV radiation is chosen as the resin to which the original fine-featured pattern is transferred. This approach is called an optical transfer process.

In the nanoimprint processing technology using the optical transfer process, a special photocurable resin must be used but, on the other hand, compared to the thermal transfer process, the optical transfer process has the advantage of reducing the dimensional errors in finished products due to the thermal expansion of transfer printing plates or printing media. Other advantages that are related to the apparatus include elimination of the need for equipping it with a heating mechanism and providing accessories such as for performing temperature elevation, temperature control, and cooling. There is a further advantage concerning the nanoimprint apparatus taken as a whole and that is elimination of the need for design considerations against thermal distortions, such as heat insulation.

An example of nanoimprint apparatuses based on the optical transfer process is described in JP 2008-12844A. This apparatus is so designed that a stamper capable of transmitting UV light is urged against a photocurable resin coated transfer substrate and irradiated with UV light from above. The stamper has a predetermined pattern of fine structures formed in the surface that is to be pressed against the transfer substrate.

FIG. 7 in the accompanying drawings is a schematic diagram showing major steps in a fine-structure transfer method involving the nanoimprint technology based on the optical transfer process. In step (a), a transfer element 100 comprising a substrate 102 coated with a resist 104 on its topside is placed in a face-to-face relationship with a stamper 108 having a fine-featured pattern 106 formed on the side that is to be brought into contact with the resist 104. In step (b), the stamper 108 is pressed against the resist-coated surface of the transfer element 100. In step (c), ultraviolet (UV) light is applied to the stamper 108 from above, whereby the resist 104 is hardened. Then, in step (d), the stamper 108 is detached from the transfer element 100, leaving a patterned layer 110 on a surface of the substrate 102 of the transfer element 100. The patterned layer 110 is the obverse image of the fine-featured pattern 106.

The stamper 108 is made of a light-transmitting material. It may be formed of a rigid material such as glass, quartz or sapphire; alternatively, it may be formed of a soft and elastic material such as a polymer. The substrate 102 is made of a known, conventionally used material selected from among silicone, glass, aluminum alloys, synthetic resins, etc. The substrate 102 may be exemplified by an annular, doughnut-shaped disk of substrate such as HDD, CD or DVD having a through-hole formed in the center. Depending on the need, the substrate 102 may have a common thin film such as a metal layer, a resin layer or an oxide film layer formed on a surface to provide a multi-layered structure. The resist 104 may comprise a synthetic resin material to which a photosensitive material has been added. Examples of the synthetic resin material that can be used include ones based on cycloolefin polymers, polymethyl methacrylate (PMMA), polystyrene polycarbonate, polyethylene terephthalate (PET), polylactic acid (PLA), polypropylene, polyethylene, polyvinyl alcohol (PVA), etc. Examples of the photosensitive material include peroxides, azo compounds (e.g., azobisisobutyronitrile), keteones (e.g., benzoin and acetone), diazoaminobenzene, metal-containing complex salts, dyes, etc. The resist 104 may be applied to the substrate 102 by various methods including, for example, a dispensing method, a spin coating method, and an ink-jet method.

In the dispensing method, the substrate 102 is directly dipped in a resist solution but this involves the defect of non-uniformity in the thickness of resist film. In the spin coating method, the resist solution is dripped to the center of the obverse side of substrate, as it is spun with suction being applied to the reverse side, whereby the resin solution is spread to cover the entire surface of the obverse side under centrifugal force. In this method, the excess resist solution is to be recovered from the peripheral edge of the substrate but, in practice, part of it moves to the reverse side of the substrate, making it difficult to achieve uniform resist deposition on both sides of the substrate.

Both the dispensing method and the spin coating method are capable of resist application to the entire surface of the substrate but, on the other hand, they cannot deposit the resist in a featured pattern such as a dotted pattern at specified sites.

The ink-jet method uses an ink-jet printer; with an ink-jet head or the substrate being scanned in an XY plane, the resist is applied from the ink-jet head onto a surface of the substrate. In the ink-jet method, the resist can be applied in a dotted pattern to give an accurately controlled deposit and, in addition, it is applied to only the required areas; thus, the ink-jet method is an economical approach that assures minimum waste of the resist solution being applied.

However, if the conventional ink-jet printer is used in resist application to an annular, doughnut-shaped disk of substrate, it achieves only low operating efficiency since it is capable of resist application to one side at a time. As a further problem, since the ink-jet head or the substrate is scanned in an XY plane while the resist 104 is applied, spots of the resist 104 are deposited linearly with respect to the XY plane and, if the fine-featured pattern 106 on the stamper 108 is concentric, a defect arises in that some of the deposited spots 104 will not be in alignment with this concentric pattern. The occurrence of such resist spots that are not in alignment with the fine-featured pattern 106 on the stamper 108 will eventually lower the performance of the final product such as a magnetic disk; hence, it is strongly desired to apply the resist 104 such that the deposited spots will be in complete alignment with the fine-featured pattern 106 on the stamper 108.

### SUMMARY OF THE INVENTION

An object, therefore, of the present invention is to provide an apparatus for resist application that enables spots of a resist to be deposited in a concentric pattern on an annular, doughnut-shaped disk of substrate with respect to its center and which is also capable of simultaneous application of the resist to both sides of the substrate.

Another object of the present invention is to provide a method for resist application that enables spots of a resist to be deposited in a concentric pattern on an annular, doughnut-shaped disk of substrate with respect to its center and which is also capable of simultaneous application of the resist to both sides of the substrate.

The first object of the present invention can be attained by an apparatus for resist application which comprises:

a motor for rotating an annular disk of substrate having a through-hole in the center, the motor having a rotating shaft that is to be inserted into or removed from the through-hole;

two ink-jet heads provided on the obverse and reverse sides, respectively, of the annular disk of substrate in such a manner that the heads are not in contact with those sides; and

a carriage for causing the two ink-jet heads to move radially inward or outward with respect to the annular disk of substrate.

The second object of the present invention can be attained by a method for resist application which comprises:

causing an annular disk of substrate having a through-hole in the center to slip over the rotating shaft of a motor for rotating the annular disk of substrate;

providing two ink-jet heads on the obverse and reverse sides, respectively, of the annular disk of substrate in such a manner that the heads are not in contact with those sides; and

causing the two ink-jet heads to move radially inward or outward with respect to the annular disk of substrate as the latter is being rotated by means of the motor.

According to the apparatus and method for resist application of the present invention, the resist is applied to the rotating annular disk of substrate having a through-hole in the center from the two ink-jet heads on the obverse and reverse sides of the substrate as they are moved radially inward or outward with respect to the substrate; this enables the resist to be deposited in a concentric pattern simultaneously on both the obverse and reverse sides of the substrate. As a result, not only is the deposited resist pattern in complete alignment with the fine-featured pattern on the stamper but also the overall application time is reduced to one half the time heretofore required in the art.

### BRIEF DESCRIPTION OF THE DRAWINGS

FIG. 1 is a plan view showing an example of the apparatus for resist application according to the first aspect of the present invention.

FIG. 2 is a front view of the apparatus for resist application that is shown in FIG. 1.

FIG. 3 is a block diagram illustrating an example of control by the method of resist application according to the second aspect of the present invention.

FIG. 4(a) is a partially enlarged plan view showing an outline of a resist pattern as deposited by the prior art.

FIG. 4(b) is a partially enlarged plan view showing an outline of a resist pattern as deposited by the apparatus for resist application according to the first aspect of the present invention.

FIG. 5 is a front view showing another example of the apparatus for resist application according to the first aspect of the present invention.

FIG. 6 is a partially enlarged plan view showing an outline of another example of a resist pattern as deposited by the apparatus for resist application according to the first aspect of the present invention.

FIG. 7(a)-7(d) are schematic diagrams showing major steps in a fine-structure transfer method involving the nanoimprint technology based on the optical transfer process.

### DETAILED DESCRIPTION

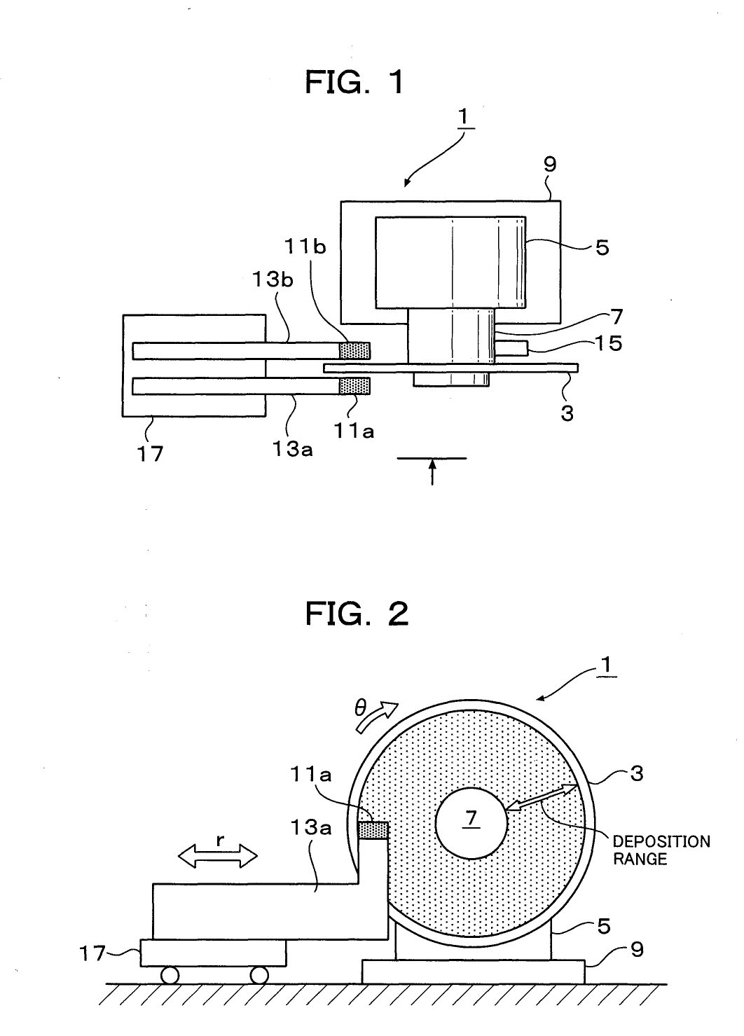

Embodiments of the apparatus for resist application according to the first aspect of the present invention are specifically described below with reference to the accompanying drawings. FIG. 1 is a plan view showing an example of the apparatus for resist application according to the first aspect of the present invention. FIG. 2 is a front view of the apparatus for resist application that is shown in FIG. 1. The apparatus generally indicated by 1 has a motor 5 for rotating an annular disk of substrate 3. The motor 5 has a rotating shaft 7. As shown, the rotating shaft 7 protrudes outward of the motor 5 and detachably holds the annular disk of substrate 3 in its end portion. The rotating shaft 7 is equipped with an encoder 15. The encoder 15 is used to detect the rotation reference position and angle of the rotating shaft 7. The motor 5 is mounted on a base 9. The motor 5 is a device capable of holding and precisely rotating the annular disk of substrate 3 and it is typically a spindle motor or a stepper motor. Two ink-jet heads 11a and 11b are provided on opposite sides of the annular disk of substrate 3 in such a way that the latter is held between the two heads without contacting them. The ink-jet heads 11a and 11b are supported by two spaced support arms 13a and 13b, respectively. The annular disk of substrate 3 is capable of getting into the gap between the support arms 13a and 13b as it is rotating. The support arms 13a and 13b are secured to the main body of an ink-jet printer. Although not shown, a resist solution feed tank for supplying a resist solution to each ink-jet head may be provided for the support arms 13a and 13b. If desired, the resist solution feed tank may be provided in other locations. The support arms 13a and 13b are mounted on a carriage 17. The carriage 17 is capable of moving the ink-jet heads 11a and 11b radially inward or outward with respect to the annular disk of substrate 3. The carriage 17 may be selected from among all types that are capable of linear reciprocal movements, as exemplified by a linear motor, a servomotor, a stepper motor, and a ball screw mechanism.

To ensure that the resist is deposited uniformly on a disk surface per unit area by the ink-jet method, either one of the following two methods may be employed.

(A) Given the same number of dots to be deposited on one circumference, the deposit of one dot is adjusted by diameter. In this method, the circumference increases with the increasing radial distance from the center of the disk and, hence, given the same number of dots to be deposited on one circumference, the distance between dots will also increase toward the outer perimeter of the disk. To deal with this situation, the deposit of one dot is increased toward the outer perimeter of the disk.
(B) While the disk is rotating, the carriage is moved by spiral scan and an ejection signal is generated at equal time intervals on the spiral path. In this case, the head position as determined by the movement of the carriage and the rpm of the motor are controlled in such a way as to provide a constant peripheral speed. Since the resist is deposited at equal time intervals on the spiral path, the deposit of the resist per dot is the same and the distance between dots increases in inverse proportion to radius, i.e., the dots are more spaced apart as they are located closer to the center of the disk.

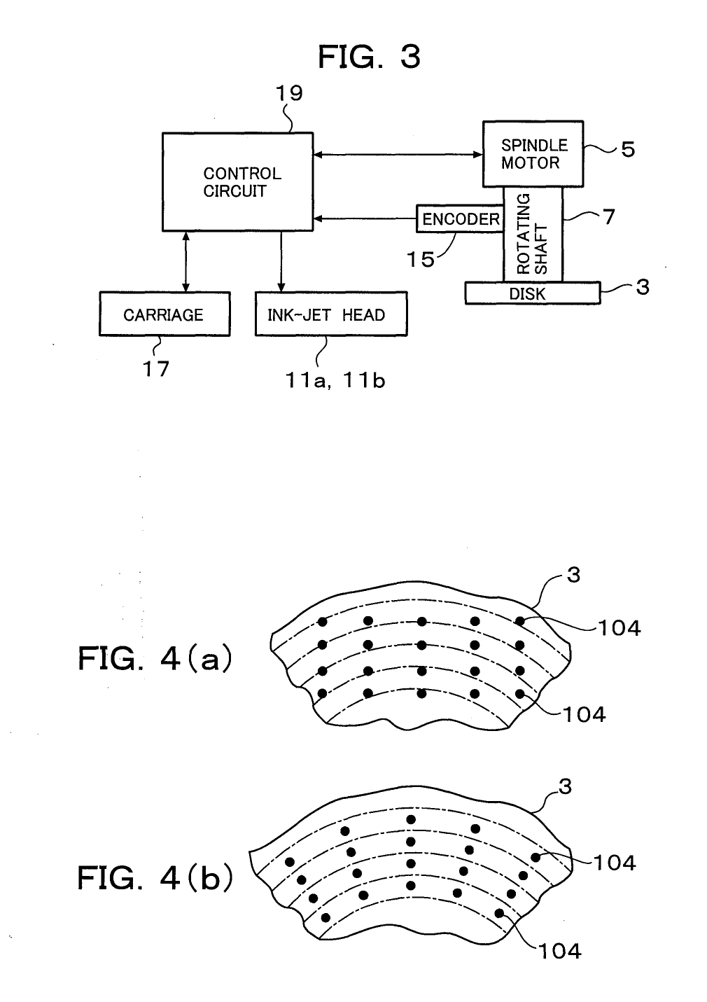

FIG. 3 is a block diagram illustrating an example of control by the method of resist application according to the second aspect of the present invention. The operation of depositing a resist solution in a concentric pattern simultaneously on the obverse and reverse sides of the annular disk of substrate is described below with reference to FIG. 3.

Step 1: First, the annular disk of substrate 3 is slipped over the rotating shaft 7 of a spindle motor 5. The encoder 15 supplies a control circuit 19 with a rotation reference position signal (index signal) and an angle signal for the rotating shaft 7. The control circuit 19 sends a signal for moving the carriage 17 to the location at which resist application is to be started (e.g. a predetermined radial position on the annular disk of substrate 3) and when the carriage 17 assumes the predetermined position, a signal indicating that event is sent to the control circuit 19.
Step 2: Thereafter, the control circuit 19 sends a rotation drive signal to the spindle motor 5, causing the spindle to rotate at a predetermined rpm. On the basis of the angle signal for the rotating shaft 7, the control circuit 19 supplies the ink-jet heads 11a and 11b with a signal for starting the ejection of the resist solution, whereupon the resist solution is ejected such that it is deposited on both sides of the annular disk of substrate 3 on a preset angular pitch.
Step 3: Throughout the drive of the spindle motor 5, the rotation reference position signal (index signal) and angle signal for the rotating shaft 7 are sent from the encoder 15 to the control circuit 19. For each predetermined radial position, the encoder 15 detects whether or not the annular disk of substrate 3 has made a full rotation. If not, the process returns to step 2. If the encoder 15 detects that the annular disk of substrate 3 has made a full rotation and sends the relevant signal to the control circuit 19, the latter supplies the ink-jet heads 11a and 11b with a signal for stopping the ejection of the resist solution and also sends a signal to stop the rotation of the spindle motor 5.
Step 4: Depending on the next radial position, the control circuit 19 changes the ink-jet drive voltage so as to change the amount in which the resist solution is to be ejected. This is in order to compensate for the variation that the change in radius causes to the equiangular circumferential distance. As a result, it becomes possible to ensure that the resist is deposited uniformly on a disk surface per unit area by the ink-jet method. For instance, the annular disk of substrate 3 has a greater circumference toward its outer perimeter and receives fewer dots than toward its center, so adjustment is made in such a way that the resist solution is ejected in a greater amount per dot.
Step 5: Subsequently, the control circuit 19 sends a signal for moving the carriage 17 in a predetermined direction with respect to the annular disk of substrate 3 by a distance equal to the transverse dimension of the head (i.e., by one pitch or print width).
Step 6: When the carriage 17 is detected to have moved by one pitch, the foregoing steps (2) to (5) are repeated.
Step 7: The encoder 15 detects whether or not the carriage 17 has reached the location for the resist application to end. If the carriage 17 has not reached this location, the foregoing steps (2) to (5) are repeated until the carriage 17 reaches this location, namely, until the resist is applied to the entire deposition range of the annular disk of substrate 3. If the carriage 17 has reached that location, the control circuit 19 drives the carriage 17 such that it retracts the ink-jet heads 11a and 11b radially outward until they go beyond the outer perimeter of the annular disk of substrate 3. In this way, the resist can be deposited in a concentric pattern simultaneously on both the obverse and reverse sides of the annular disk of substrate 3. The carriage 17 may be moved from the outer perimeter toward the center of the annular disk of substrate 3; conversely, it may be moved from the center toward the outer perimeter of the annular disk of substrate 3.

Alternatively, the control circuit 19 shown in FIG. 3 may be so designed that the linear reciprocal movements of the ink-jet heads 11a and 11b are operatively associated with the rotating motion of the annular disk of substrate 3, thereby ensuring that the resist is deposited in a concentric pattern simultaneously on both the obverse and reverse sides of the annular disk of substrate 3. In this embodiment, the motor 5 is not the spindle motor but a stepper motor. The process typically goes through the following steps.

Step 1: First, the annular disk of substrate 3 is slipped over the rotating shaft 7 of the stepper motor 5; thereafter, a signal indicating that the annular disk of substrate 3 has been moved by the carriage 17 to the location at which resist application by the ink-jet heads 11a and 11b is to be started (e.g. a predetermined radial position on the annular disk of substrate 3) is sent from the carriage 17 to the control circuit 19.
Step 2: Subsequently, the control circuit 19 supplies the ink-jet heads 11a and 11b with a signal for starting the ejection of the resist solution, whereupon the resist solution is deposited at predetermined areas.
Step 3: Then, depending on the next radial position, the control circuit 19 changes the ink-jet drive voltage so as to change the amount in which the resist solution is to be ejected. This is in order to compensate for the variation that the change in radius causes to the equiangular circumferential distance. As a result, it becomes possible to ensure that the resist is deposited uniformly on a disk surface per unit area by the ink-jet method. For instance, the annular disk of substrate 3 has a greater circumference toward its outer perimeter and receives fewer dots than toward its center, so adjustment is made in such a way that the resist solution is ejected in a greater amount per dot.
Step 4: Subsequently, the control circuit 19 moves the carriage 17 by one pitch in a predetermined direction (i.e., radially inward or outward) and, at the new position it assumes, the control circuit 19 supplies the ink-jet heads 11a and 11b with a signal for starting the ejection of the resist solution on the basis of the amount of resist solution ejection that has been changed in step (3); in response to that signal, the resist solution is deposited from the ink-jet heads 11a and 11b.
Step 5: The control circuit 19 detects whether or not the carriage 17 has moved from the application start location to the end location for one radial direction. If the carriage 17 has not reached the application end location, the control circuit 19 repeats the foregoing steps (2) to (4).
Step 6: If the carriage 17 has reached the application end location, the control circuit 19 sends a signal for returning the carriage 17 to the application start location; at the same time, a rotation signal is sent to the stepper motor 5, causing the rotating shaft 7 to rotate through a predetermined angle, and the encoder 15 supplies the control circuit 19 with a rotation reference position signal (index signal) and an angle signal for the rotating shaft 7.
Step 7: The encoder 15 detects whether or not the annular disk of substrate 3 has made a full rotation. If not, the foregoing steps (2) to (6) are repeated. If yes, the control circuit 19 drives the carriage 17 such that it retracts the ink-jet heads 11a and 11b radially outward until they go beyond the outer perimeter of the annular disk of substrate 3. In this way, the resist can be deposited in a concentric pattern simultaneously on both the obverse and reverse sides of the annular disk of substrate 3.

FIG. 4(a) is a partially enlarged plan view showing an outline of a resist pattern as deposited by the prior art, and FIG. 4(b) is a partially enlarged plan view showing an outline of a resist pattern as deposited by the apparatus for resist application according to the first aspect of the present invention. As shown in FIG. 4(a), when the resist is applied to an annular disk of substrate with the conventional ink-jet printer, resist spots 104 are deposited while the ink-jet head or the substrate is scanned in an XY plane, so the spots 104 are deposited linearly with respect to the XY plane and many of them will become out of alignment with the tracks on the annular disk of substrate (as indicated by the imaginary lines in the drawing). As a result, only poorly pattern transfer will be obtained from the stamper 108.

This is in sharp contrast with the case shown in FIG. 4(b), where the apparatus for resist application according to the first aspect of the present invention enables all resist spots 104 to be aligned concentrically along the tracks on the annular disk of substrate (as indicated by the imaginary lines in the drawing). As a result, accurate pattern transfer can be obtained from the stamper 108.

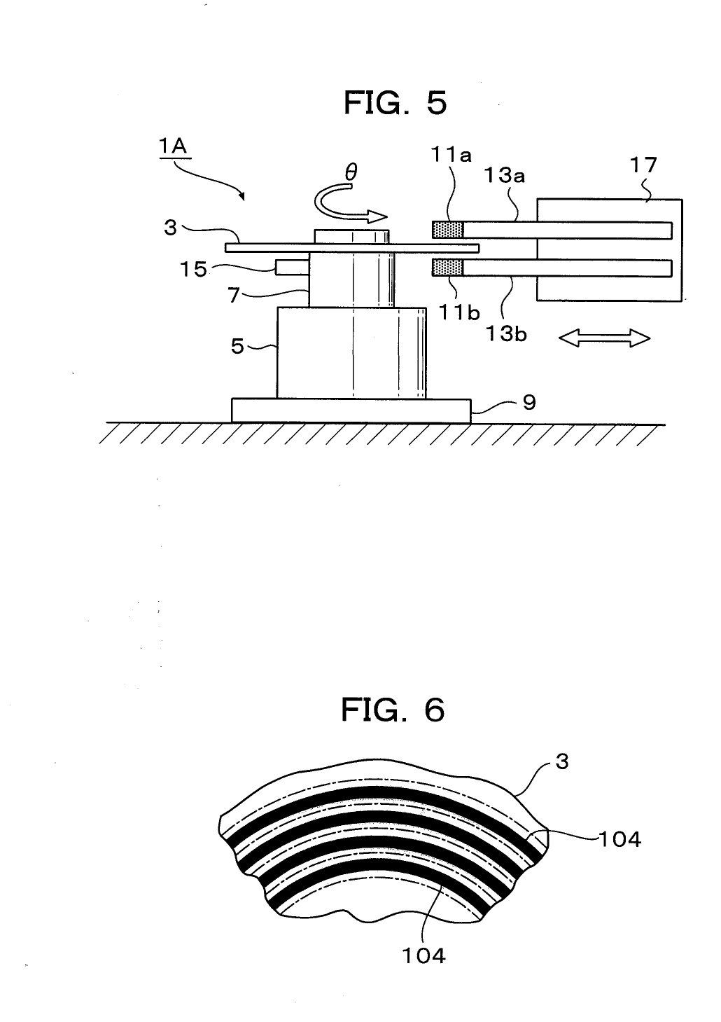

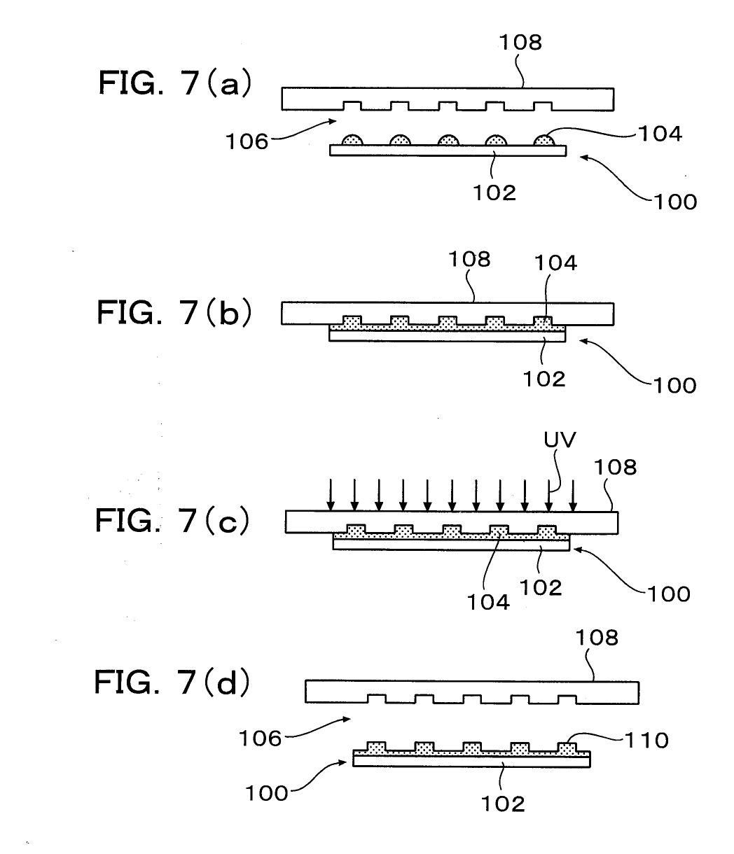

While the apparatus and method for resist application according to the first and second aspects of the present invention have been described on the foregoing pages with reference to the preferred embodiments, it should be understood that the present invention is by no means limited to those embodiments but may be modified in various ways. For example, the annular disk of substrate 3 which, in FIGS. 1 and 2, is rotated in a vertical position may be rotated in a horizontal position as shown in FIG. 5. In addition, the resist 104 need not be deposited in a dotted pattern as shown in FIG. 4; it may be deposited in any other pattern that depends on the shape of the fine-featured pattern 106 on the stamper 108, for example, a resist pattern consisting of concentric rings as shown in FIG. 6.

It should also be noted that the apparatus for resist application according to the first aspect of the present invention which is capable of simultaneous resist deposition on both the obverse and reverse sides of an annular disk of substrate may of course be used in such a way that the resist is deposited on only one side of the substrate.

1. An apparatus for resist application which comprises:
a motor for rotating an annular disk of substrate having a through-hole in the center, the motor having a rotating shaft that can be inserted into or removed from the through-hole;
two ink-jet heads provided on the obverse and reverse sides, respectively, of the annular disk of substrate in such a manner that the heads are not in contact with those sides; and
a carriage for causing the two ink-jet heads to move radially inward or outward with respect to the annular disk of substrate.

2. The apparatus for resist application according to claim 1, wherein the motor for rotating an annular disk of substrate is selected from the group consisting of a spindle motor and a stepper motor.

3. The apparatus for resist application according to claim 1, wherein the two ink-jet heads are supported by two spaced support arms, respectively.

4. The apparatus for resist application according to claim 1, wherein the carriage is one capable of linear reciprocal movements that is selected from the group consisting of a linear motor, a servomotor, a stepper motor, and a ball screw mechanism.

5. The apparatus for resist application according to claim 1, wherein the rotating shaft is equipped with an encoder.

6. A method for resist application which comprises:
causing an annular disk of substrate having a through-hole in the center to slip over the rotating shaft of a motor for rotating the annular disk of substrate;
providing two ink-jet heads on the obverse and reverse sides, respectively, of the annular disk of substrate in such a manner that the heads are not in contact with those sides; and
causing the two ink-jet heads to move radially inward or outward with respect to the annular disk of substrate as the latter is rotated by means of the motor.

7. The method for resist application according to claim 6, wherein a resist is applied as the annular disk of substrate is rotated continuously with a spindle motor.

8. The method for resist application according to claim 6, wherein a resist is applied as the annular disk of substrate is rotated stepwise with a stepper motor.
